(19) United States
(12) Patent Application Publication
(10) Pub. No.: US 2006/0182414 A1
(43) Pub. Date: Aug. 17, 2006

(54) Video recorder/player and automatic recording method

(75) Inventor: Sung Min So, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/253,561

(22) Filed: Oct. 20, 2005

(30) Foreign Application Priority Data
Feb. 17, 2005 (KR) 2005-13208

(51) Int. Cl. H04N 5/91

(52) U.S. Cl. 386/94

(57) ABSTRACT

A video recorder/player and an automatic recording method are provided where a broadcast signal to be recorded is received, a copy protection signal contained in the broadcast signal is detected, and the broadcast signal is recorded. A controller controls the recording unit to selectively record a broadcast signal containing no copy protection signal, based on the result of the detection by the copy protection signal detector.

### CROSS-REFERENCE TO RELATED APPLICATION

This application claims the benefit under 35 U.S.C. §119(a) from Korean Patent Application No. 2005-13208, filed on Feb. 17, 2005 in the Korean Intellectual Property Office, the entire disclosure of which is hereby incorporated by reference.

### BACKGROUND OF THE INVENTION

1. Field of the Invention

The present invention relates to a video recorder/player and an automatic recording method. More particularly, the present invention relates to a video recorder/player and an automatic recording method which selectively record a broadcast signal containing no copy protection signal from among received broadcast signals.

2. Description of the Related Art

A conventional video signal recorder generally comprises a tuner, a record signal processing circuit, a signal detection circuit, a record control signal input unit, and a system controller as described, for example, in Japanese Patent Publication No. 10-261267.

The tuner receives and detects an RF signal of a TV broadcast, and outputs a baseband video signal to the record signal processing circuit. The record signal processing circuit performs processing such as conversion and band compression on the video signal and outputs it to a recording medium. The recording medium includes a magnetic tape, a CD-ROM, an optical disc, a hard disk, a semiconductor memory, and the like. The signal detection circuit detects a synchronous signal included in the video signal provided from the record signal processing circuit, and outputs the detection result to the system controller. The system controller controls the tuner or the recording medium according to a signal input from the signal detection circuit or according to a signal output by manipulation of the signal input unit by the user.

The conventional video signal recorder determines whether a broadcast (or a program) is started or ended, by counting horizontal or vertical synchronous signals carried in the broadcast signal. If it is determined that a broadcast is started, the conventional video signal recorder automatically starts recording the broadcast. If it is determined that a broadcast is ended, the conventional video signal recorder automatically stops recording the broadcast. In this manner, the conventional video signal recorder can properly record a broadcast even if the broadcast is resumed after being temporarily stopped.

However, if a conventional video signal recorder receives a broadcast signal containing a copy protection signal when starting programmed recording, the conventional video signal recorder cannot properly record the received broadcast signal. For example, if the user desires to record a program A and thus programs the recorder to start recording at a scheduled broadcast start time of the program A but a program B containing a copy protection signal, which was scheduled to be broadcast prior to the start time of the program A, is received at the start time of the program A due to delay of the broadcasting, the conventional video signal recorder stops recording at the start time of the program A, failing to record the desired program A. Even if the program B is recorded, the conventional video signal recorder cannot play back the program B since the program B contains the copy protection signal, thereby wasting the storage space of a recording medium of the recorder.

### SUMMARY OF THE INVENTION

Therefore, it is an exemplary aspect of the present invention to provide a video recorder/player and an automatic recording method which can selectively record a broadcast signal containing no copy protection signal from among received broadcast signals.

Additional exemplary aspects and/or advantages of the present invention will be set forth in part in the following description of the exemplary embodiments of the present invention and, in part, may be appreciated or learned through practice by skilled artisans from the description of the exemplary embodiments of the present invention.

In accordance with exemplary implementations of the present invention, the above exemplary and/or other aspects of the present invention may be achieved by the provision of a video recorder/player comprising a broadcast signal receiver for receiving a broadcast signal to be recorded; a copy protection signal detector for detecting a copy protection signal contained in the broadcast signal; a recording unit for recording the broadcast signal; and a controller for controlling the recording unit to selectively record a broadcast signal containing no copy protection signal, based on a result of the detection by the copy protection signal detector.

### BRIEF DESCRIPTION OF THE DRAWINGS

These and/or other exemplary aspects and advantages of the exemplary implementations of the present invention will become apparent and more readily appreciated from the following description of the exemplary embodiments, taken in conjunction with the accompanying drawings in which like reference symbols indicate the same or similar components, wherein:

FIG. 1 is a block diagram of a video recorder/player according to an exemplary embodiment of the present invention; and

FIG. 2 is a flow chart of an example of an automatic record operation of the video recorder/player shown, for example, in FIG. 1 according to an exemplary implementation of the present invention.

### DETAILED DESCRIPTION OF EXEMPLARY EMBODIMENTS

Reference will now be made in detail to the exemplary embodiments of the present invention, examples of which are illustrated in the accompanying drawings, wherein, as noted above, like reference numerals refer to the like elements throughout. The exemplary embodiments of the present invention are described below to explain exemplary implementations of the present invention with reference to the drawing figures.

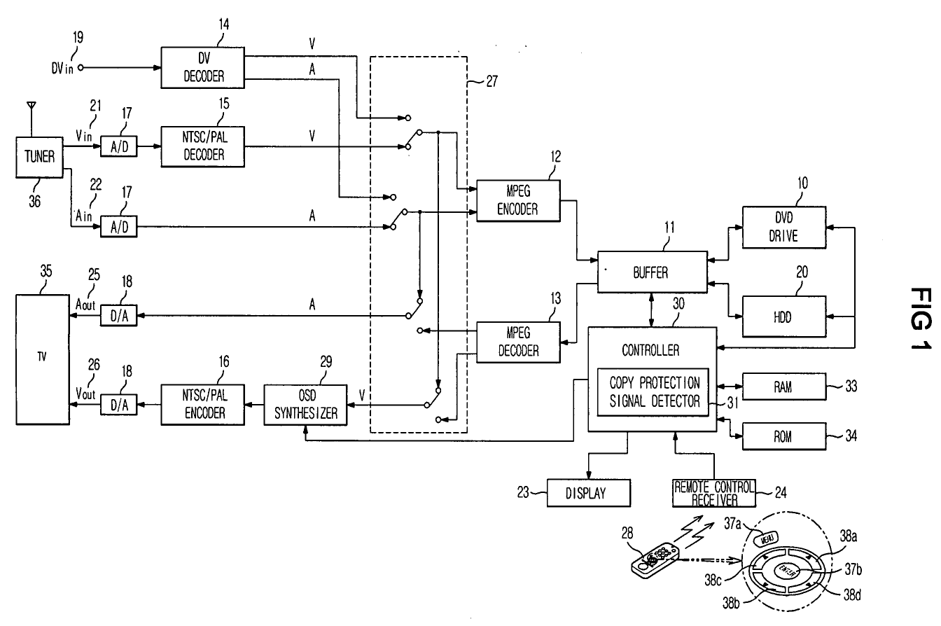

As shown in FIG. 1, a DVD recorder according to an exemplary embodiment of the present invention comprises a plurality of inputs 19, 21 and 22, a plurality of outputs 25 and 26, a plurality of A/D converters 17, a plurality of D/A converters 18, a DV decoder 14, an NTSC/PAL decoder 15, and an NTSC/PAL encoder 16. The DVD recorder also comprises a switching circuit 27, an MPEG encoder 12, an MPEG decoder 13, a controller 30, an On Screen Display (OSD) synthesizer 29, a buffer 11, a DVD drive 10, and an HDD 20. The DVD recorder further comprises a display unit 23, a remote control receiver 24, a RAM 33, and a ROM 34.

The inputs of the DVD recorder include a digital interface terminal (Dvin) 19, a video input (Vin) 21, and an audio input (Ain) 22. AV data in digital video (DV) format is input to the digital interface terminal 19. Video signals in NTSC or PAL format received from a tuner 36 or a set-top box are input to the video input 21, and audio signals received from the tuner 36 or the set-top box are input to the audio input 22.

The outputs of the DVD recorder include a video output (Vout) 25 and an audio output (Aout) 26. The video output 26 outputs video signals in NTSC or PAL format to the TV 35 connected to the video output 26, and the audio output 25 outputs audio signals to the TV 35 connected to the audio output 25.

The DV decoder 14 converts AV data in digital video format received through the digital interface terminal 19 into video and audio signals in International Telecommunication Union (ITU)-R BT format. The NTSC/PAL decoder 15 converts a video signal in NTSC or PAL format received through the video input 21 into a video signal in ITU-R BT format. The NTSC/PAL encoder 16 converts a video signal in ITU-R BT format output from the MPEG decoder 13 into a video signal in NTSC or PAL format.

The switching circuit 27 allows a video signal output from the NTSC/PAL decoder 15 to be transferred to the MPEG encoder 12 and the OSD synthesizer 29, and allows an audio signal received through the audio input (Ain) 22 to be transferred to the MPEG encoder 12 and the audio output (Aout) 25. When AV data in digital video format is recorded, the switching circuit 27 allows a video signal output from the DV decoder 14 to be transferred to the MPEG encoder 12 and the OSD synthesizer 29, and allows an audio signal output from the DV decoder 14 to be transferred to the MPEG encoder 12 and the audio output (Aout) 25. On the other hand, when AV data is played back, the switching circuit 27 allows a video signal output from the MPEG decoder 13 to be transferred to the OSD synthesizer 29, and allows an audio signal output from the MPEG decoder 13 to be transferred to the audio output (Auot) 25.

The MPEG encoder 12 compresses and encodes, using the MPEG-2 standard, a video signal in ITU-R BT format and a digitized audio signal to generate an AV data stream. Conversely, the MPEG decoder 13 converts an AV data stream into a video signal in ITU-R BT format.

The controller 30 includes a copy protection signal detector 31 for detecting a copy protection signal carried in a TV signal. In digital broadcasting, a copy protection signal is carried in a specific line. The copy protection signal detector determines whether or not a copy protection signal is carried in a TV signal in the specific line. The controller 30 also controls each element of the DVD recorder. The controller 30 produces an OSD image for display on the TV 35 connected to the DVD recorder, and provides the produced OSD image to the OSD synthesizer 29. The OSD synthesizer 29 then allows the OSD image received from the controller 30 to be displayed on the TV 35. The buffer 11 temporarily stores an AV data stream. The DVD drive 10 writes or reads AV data to or from a DVD disc loaded in the DVD drive 10. The HDD 20 stores various data, independently of the DVD drive 10.

The remote control receiver 24 receives a signal transmitted from a remote controller 28 and transfers it to the controller 30. The remote controller 28 includes a menu button 37a used to display or close a menu screen on the TV 35 connected to the DVD recorder, an enter button 37b used to select an item, and up, down, left, and right navigation buttons 38a, 38b, 38c, and 38d used to move between items displayed on the screen.

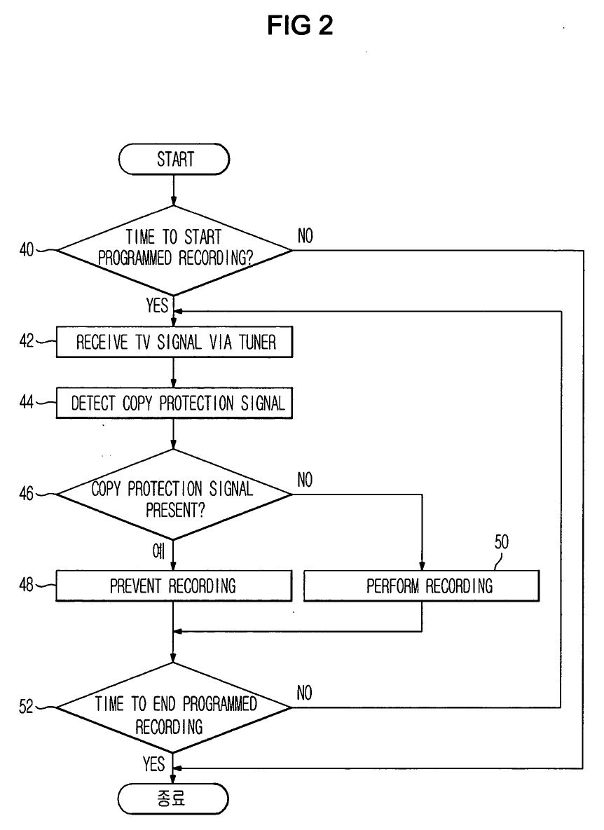

An example of an automatic recording method for a DVD recorder according to an exemplary embodiment of the present invention will now be described with reference to FIG. 2. To record a TV signal, the user, for example, presses the menu button 37a on the remote controller 28 to display a number of menu items (for example, record, playback and setup items), and selects a recording item of the displayed menu items to set programmed recording.

The controller 30 determines whether or not the time to start the programmed recording is reached (40). If the programmed recording start time is reached, the controller 30 controls the tuner 36 to receive a TV signal of a channel set by the user (42). The TV signal (or video signal) received through the tuner 36 is transferred to the controller 30 via the NTSC/PAC decoder 15, the MPEG encoder 12, and the buffer 11. If the controller 30 receives the TV signal, the copy protection signal detector 31 in the controller 30 detects whether there is a copy protection signal in the received TV signal (44). Based on the result of the detection by the copy protection signal detector 31, the controller 30 determines whether or not a copy protection signal is carried in the TV signal (46).

If a copy protection signal is carried in the TV signal, the controller 30 does not perform recording (48). If no copy protection signal is carried in the TV signal, the controller 30 controls the DVD drive 10 or the HDD 20 to store the TV signal on a DVD disc or the HDD 20 (50).

The controller 30 then determines whether the time to end the programmed recording is reached (52). If the programmed recording end time is reached, the controller 30 terminates the procedure. If the programmed recording end time is not reached, the controller 30 returns to step 42. If the controller 30 determines that a copy protection signal is not carried in the TV signal before the recording end time is reached, the controller 30 controls the DVD drive 10 or the HDD 20 to store the TV signal on a DVD disc or the HDD 20.

Although the above exemplary embodiments of the present invention have been described with reference to an exemplary embedded system in which the copy protection signal detector 31 is included in the controller 30, the copy protection signal detector 31 may also be provided as, for example, one chip separated from the controller 30. For example, a copy protection signal detection chip may be provided in the DVD recorder upstream of the MPEG encoder 12.

As is apparent from the above description, exemplary implementations of a video recorder/player and an automatic recording method according to exemplary embodiments of the present invention can, for example, selectively record only a TV signal containing no copy protection signal from among received TV signals, thereby, for example, preventing the waste of storage space of a recording medium which is caused by recording TV signals containing a copy protection signal.

In addition, if, for example, a TV signal containing a copy protection signal is received at the start time of programmed recording of a desired program, the video recorder/player and the automatic recording method according to exemplary embodiments of the present invention can, inter alia, properly record the desired program by waiting without terminating the recording and then starting the recording when a signal containing no copy protection signal is received.

Although a few exemplary embodiments of the present invention have been shown and described, it will be appreciated by those skilled in the art that changes and variations may be made without departing from the principles and spirit of the invention, the scope of which is defined in the claims and their equivalents.

What is claimed is:

1. A video recorder/player comprising:
a broadcast signal receiver for receiving a broadcast signal to be recorded;
a copy protection signal detector for detecting a copy protection signal contained in the broadcast signal;
a recording unit for recording the broadcast signal; and
a controller for controlling the recording unit to selectively record a broadcast signal containing no copy protection signal, based on a result of the detection by the copy protection signal detector.

2. The video recorder/player according to claim 1, wherein, if the broadcast signal contains the copy protection signal, the controller controls the recording unit not to record the broadcast signal, and if the broadcast signal contains no copy protection signal, the controller controls the recording unit to record the broadcast signal.

3. The video recorder/player according to claim 1, wherein the controller comprises the copy protection signal detector.

4. An automatic recording method for a video recorder/player, the method comprising:
receiving a broadcast signal;
determining whether or not the broadcast signal comprises a copy protection signal; and
selectively recording the broadcast signal comprising no copy protection signal.

5. The automatic recording method according to claim 4, wherein, if the broadcast signal comprises the copy protection signal, the broadcast signal is prevented from being recorded, and if the broadcast signal comprises no copy protection signal, the broadcast signal is recorded in a storage medium.

6. The video recorder/player according to claim 1, wherein the copy protection signal detector is on a chip separated from the controller.

7. The video recorder/player according to claim 1, wherein the controller controls the recording unit to record only the broadcast signal containing no copy protection signal based on the result of the detection by the copy protection signal detector.

8. The automatic recording method according to claim 4, wherein the selectively recording comprises recording only the broadcast signal comprising no copy protection signal.
